(19) United States
(12) Patent Application Publication
(10) Pub. No.: US 2021/0312008 A1
(43) Pub. Date: Oct. 7, 2021

(54) FORMATTING VIEWS USING TRANSFORMER PLUGINS

(71) Applicant: Hewlett-Packard Development Company, L.P., Spring, TX (US)

(72) Inventor: Rafael Dal Zotto, Porto Alegre (BR)

(73) Assignee: Hewlett-Packard Development Company, L.P., Spring, TX (US)

(21) Appl. No.: 17/270,100

(22) PCT Filed: Nov. 19, 2018
(86) PCT No.: PCT/US2018/061768

§ 371 Date: Feb. 22, 2021

(51) Int. Cl. G06F 16/957; G06F 16/25; G06N 20/00; G06N 5/04

(52) U.S. Cl. CPC G06F 16/9577; G06F 16/258; G06N 5/04; G06N 20/00; G06F 16/254

(57) ABSTRACT

In one example, in a computer-implemented method for dynamically formatting data, a request for a service endpoint is received from a client platform. A platform identifier is extracted from the request. A transformer plugin is selected based on the platform identifier. A view of data from the service endpoint is formatted via the selected transformer plugin to visually fit the client platform. The formatted view and the data is sent to the client platform for presentation.

### BACKGROUND

Plugins are used to add specific features to existing computer programs. For example, plugins for web browsers can enable additional features such as search engines, virus scanners, or support for new file types.

### BRIEF DESCRIPTION OF THE DRAWINGS

Various features of the techniques of the present application will become apparent from the following description of examples, given by way of example only, which is made with reference to the accompanying drawings, of which:

FIG. 1 is a block diagram of an example system for formatting views using transformer plugins;

FIG. 2 is a process flow diagram illustrating an example method for formatting views using transformer plugins;

FIG. 3A is block diagram of an example apparatus including a computing device to format views using transformer plugins;

FIG. 3B is block diagram of another example apparatus to format views using transformer plugins; and

FIG. 4 is a drawing of an example machine-readable storage medium that can be used to format views using transformer plugins.

### DETAILED DESCRIPTION

Content can be provided to various software applications by a service. However, not all content provided by a service can be useful or even presentable for a particular software application. For example, a detailed weather map may not be viewable on a wearable device. Accordingly, it may not possible to present all data provided by a service. In addition, it may not possible to correctly display content received from a service at a software application even if the content is possible to present.

Described herein are techniques for formatting views using transformer plugins. As used herein, a transformer plugin refers to plugins that transform content from a particular service for a particular platform. For example, the platform can be a web browser, a communication tool, or a custom application, running on a processor, among other combinations of software and hardware. A transformer plugin can be selected based on a request from a particular platform. For example, the request can include a platform identifier that is used to select a transformer plugin for particular platform. As one example, the platform identifier is included in an extended header information of the request. In some examples, the techniques include intercepting the request and selecting a transformer plugin based on a platform identifier extracted from the request. The transformer plugin can format data received from a service in response to the request to generate a formatted view to be displayed on the platform.

The techniques described herein thus enable improved presentation of content from a shared common infrastructure across a variety of platforms. Moreover, the techniques enable different applications corresponding to platforms to be distinguished and formatted content to be generated for each accordingly. In addition, the techniques are easily extendable to new software and platforms via additional transformer plugins.

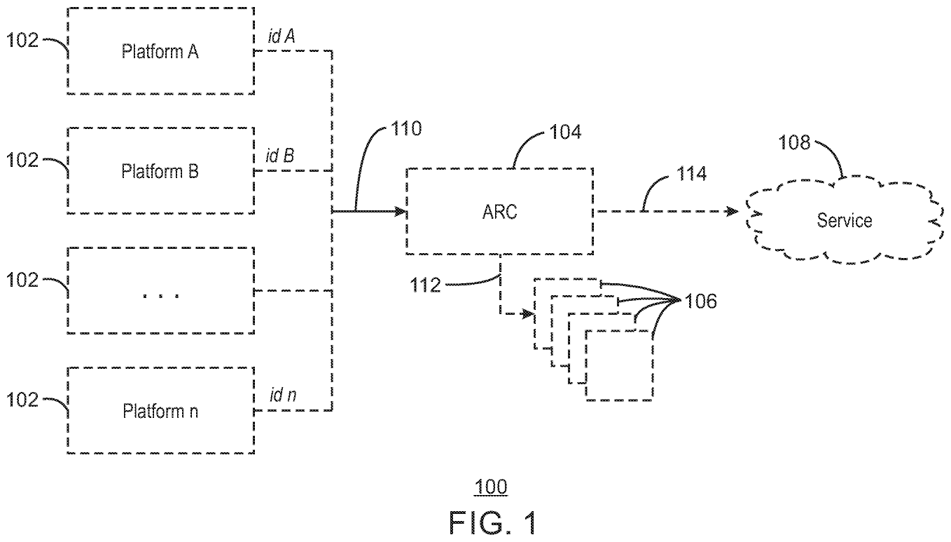

FIG. 1 is a block diagram of an example system 100 for formatting views using transformer plugins. The system 100 includes a number n of platforms 102 communicatively coupled to an adaptive response creator (ARC) 104. As one example, the platforms 102 include a mobile device application, a desktop device application, a communication tool application, a virtual assistant device application, and a wearable device application. The ARC 104 is communicatively coupled to a number of transformer plugins 106 and a service 108. In some examples, each platform 102 can have an associated transformer plugin 106. For example, each transformer plugin 106 can have an associated platform identifier. Thus, in some examples, the number of transformer plugins 106 matches the number n platforms 102. In some examples, the service 108 can be any service providing content to be displayed on platforms 102. The transformer plugins 106 include specifications of what each platform 102 can and cannot process. For example, the transformer plugins 106 can include a list of features that allow a better user experience for each platform 102.

In the example system 100, each of the platforms 102 can send a request for content including a platform identifier as indicated by arrow 110. As one example, the platform identifier is a string of alphanumeric characters associated with a particular platform 102. As one example, the platform identifier is included in an extended request header information of the request.

The ARC 104 can extract platform identifiers from the requests. For example, the ARC 104 can identify extended request header information of the request and extract the platform identifier from the extended request header information.

The ARC 104 can then select a transformer plugin 106 based on the extracted platform identifier, as indicated by an arrow 112. For example, the ARC 104 can match the extracted platform identifier with a platform identifier associated with one of the transformer plugins 106.

The ARC 104 can also forward the request to the service 108, as indicated by an arrow 114. Thus, in one example, the ARC 104 intercepts the request for the service 108 and forwards the request to the service while identifying an associated transformer plugin 106. In some examples, if the ARC 104 does not identify any platform identifier, then the ARC 104 can forward the request to the service without selecting a transformer plugin 106 or can select a default transformer plugin 106.

The service 108 can process the request and return data in response to the request. For example, the data returned can include content of various forms. In some examples, the returned data includes JavaScript Object Notation (JSON) content.

The ARC 104 can receive the returned data and send the data to the selected transformer plugin 106 for formatting. In some examples, the ARC 104 intercepts the returned data from the service and sends the returned data to the transformer plugin 106 for formatting. In some examples, if the extracted platform identifier does not match any of the platform identifiers associated with any of the transformer plugins 106, then the ARC 104 can forward the data to the requesting platform 102 without formatting a view.

The transformer plugins 106 can format the content to generate a formatted view. In some examples, the transformer plugins 106 can format not only in terms of text formatting, but also in a sense of choosing the best user interface (UI) features to be used in the output result. Thus, in some examples, the transformer plugin 106 includes some returned data while excluding other returned data from the formatted view. The formatted view thus may include a subset of the content received from the service 108 formatted for a particular platform. The formatted view of the content can be returned to the platform 102 for display.

As one example, the service 108 is a device health inspection service implemented as a data-as-a-service (DaaS). Using the techniques described herein, in response to a request for device health content, health content of devices is displayed through platforms 102 including a virtual assistant from a web user interface and a communication tool application channel. In the virtual assistant web application, tabular information can be shown along with charts. For the communication tool application, which is not able to display charts for example, similar content is displayed in a simple text format. In this example, a custom header for the request can be generated by a plugin for the communication tool application. The ARC 104 can intercept the request with the custom header and select a transformer plugin 106 corresponding to the communication tool application based on an extracted platform identifier from the custom header. The selected transformer plugin 106 includes information about the communication tool application, including that the communication tool application cannot display charts but that the communication tool application can display text. The ARC 104 can intercept content from the service 108 and send the intercepted content to the selected transformer plugin 106. The selected transformer plugin 106 can generate a formatted view in a simple text format that includes information corresponding to the charts. The ARC 104 can then send the formatted view to the platform 102 that requested the content, which is the communication tool application in this example. The communication tool application then displays the formatted view for the user. In some examples, if the ARC 104 does not detect a platform identifier or a transformer plugin 106 that corresponds to an extracted platform identifier, then a default fallback view can be used. In this case, the raw content from the service 108 is returned without formatting and rendered as is by the requestor platform 102. In some examples, as mentioned previously, the act of ‘not formatting’ can be understood as a simple transformer plugin 106 that can act as the default fallback for the system 100. For example, the default fallback view can be the view for a web user interface. Thus, the transformer plugin 106 associated with the platform 102 of the web user interface can be designated as a default transformer plugin.

In some examples, the ARC 104 can also cache formatted views. For example, the formatted views can be cached for a predefined and configurable amount of time. In some examples, caching can be performed using HTTP cache headers. For example, a “cache-control” header can be used to enable or disable caching. An “expires” header can be used to set a cache time associated with a particular cached formatted view. The cache time can be predefined by the client platform 102. The cache time can also be configurable by the transformer plugins 106. In some examples, the transformer plugin 106 can specify whether or not the formatted view is to be cached. Additionally, in some examples, the transformer plugin 106 can specify the amount of time that formatted view is to be cached. For example, the transformer plugin 106 can overriding a default n time established by the client platform 102. The cached formatted view can be provided in response to detecting identical requests form a platform within the predetermined or configured amount of time. In some examples, HTTP spec headers can be used to detect identical request. For other platforms (not HTTP), the ARC 104 can track the used parameters and filters to create a mapping between the request (filters) and the content. In this way, the ARC 104 can search for a mapping that fits the new request and, if detected, the ARC 104 can send a cached formatted view in response to the new request.

As one example, if a platform 102 sends a request for a service 108; the service 108 provides the data response and ARC 104 extracts the platform identifier and selects a transformer plugin 106 to format the view. The transformer plugin 106 can indicate that the formatted view is to be cached for a predetermined amount of time. An identical request may arrive from the same or different client within the predefined amount of time. In response to detecting that the response is identical, the ARC 104 can identify and optimize the response time by sending the cached formatted view to the client platform 102 sending the identical request. Thus, the system 100 stores the formatted view cached for a predefined and configurable amount of time. After this predefined or configured amount of time, the formatted view is discarded. Using a cached formatted view may avoid unnecessary additional access to service 108.

As another example, the service 108 is a traffic and weather service providing traffic conditions and weather details based on device location as determined using global positioning satellite (GPS) coordinates. The service 108 can use a map application programming interface (API) to fetch traffic details based on a requests coordinates. The service 108 can also use a weather application API to retrieve weather details based on the request coordinates. The service 108 can provide content to users via platforms 102 including a mobile application as well as a communication tool. For example, the mobile application can display maps and weather images, while the communication tool displays text. Again, for requests from the communication tool, a custom header for the request may be generated by a plugin for the communication tool. The ARC 104 can intercept the request with the custom header and select a transformer plugin 106 corresponding to the communication tool application based on an extracted platform identifier from the custom header. The selected transformer plugin 106 includes information about the communication tool application, including that the communication tool cannot display maps or weather images but that the communication tool application can display text. The ARC 104 can intercept content from the service 108 and send the intercepted content to the selected transformer plugin 106. The selected transformer plugin 106 can generate a formatted view in a simple text format that includes information corresponding to the weather and traffic information included in the map and the weather image. The ARC 104 can then send the formatted view to the platform 102 that requested the content, which is the communication tool application in this example. The communication tool application then displays the formatted view for the user. Similarly, a request from the mobile application can include a custom header including a platform identifier associated with the mobile application. The ARC 104 can select a transformer plugin 106 associated with the mobile application and forward the content from the service 108 to the selected transformer plugin 106. The transformer plugin 106 associated with the mobile application can then include weather images and maps visually depicting traffic conditions in the formatted view for the mobile application. The formatted view can then be sent to the mobile application for display on a mobile device.

The block diagram of FIG. 1 is not intended to indicate that the example system 100 is to include all of the components shown in FIG. 1. Further, the system 100 can include any number of additional components not shown in FIG. 1, depending on the details of the specific implementation. For example, the system 100 can include additional platforms 102, transformer plugins 106, services 108, etc.

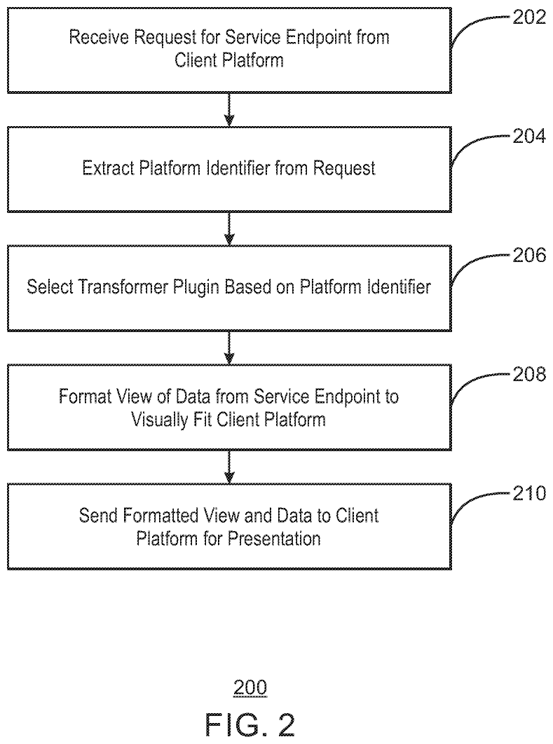

FIG. 2 is a process flow diagram illustrating an example method for formatting views using transformer plugins. The method 200 of FIG. 2 can be implemented in the adaptive response creator 104 of system 100 of FIG. 1 above or the computing device 302 below. For example, the method can be implemented using processor 304.

At block 202, a request for a service endpoint is received from a client platform. In some examples, the client platform is an application of a mobile device, a wearable device application, a virtual assistant application, or a desktop application, among other possible client platforms. In one example, the request is a Hypertext Transfer Protocol (HTTP) request. In some examples, the service endpoint can be a cloud service providing content.

At block 204, a platform identifier is extracted from the request. In some examples, including the example of HTTP requests, the extended request header information is detected in the request and the platform identifier is extracted from the extended request header information. In other examples, such as for WebSocket communications, the platform identifier can be added as part of a handshake process. As used herein, WebSocket refers to a computer communications protocol, providing full-duplex communication channels over a single Transmission Control Protocol (TCP) connection. For example, upon the connection time from the client to the service, the platform identifier information will be passed along with the request. In some examples, custom headers can be automatically added based on the communication model. For example, when creating a WebSocket connection, the client platform can pass along the platform identifier data and the ARC can check for the existence of a Sec-WebSocket-Protocol header. In some examples, the ARC can include a trained classifier to automatically generate a platform identifier based on the request. For example, the classifier can be a machine learning algorithm that can be trained on requests to automatically generate a platform identifier based on the content of the request. In some examples, the trained classifier can be used in place of or in addition to a platform identifier extractor. For example, the trained classifier can be used to generate platform identifiers based on content of the request in response to not detecting any platform identifier in the request.

At block 206, a transformer plugin is selected based on the platform identifier. For example, the transformer plugin can be selected from a number of transformer plugins, each of the transformer plugins associated with a particular client platform.

At block 208, a view of data from the service endpoint is formatted via the selected transformer plugin to visually fit the client platform. For example, the data from the service endpoint can include JSON data. In some examples, data is excluded from the formatted view. For example, the data can be excluded due to space limitations. As one example, the excluded data is maps, images, or charts. In some examples, excluded data can be replaced by a textual description of its contents. For example, a chart can be replaced by a textual description of the information included in the chart. Thus, features that best fit the platform can be included in the output formatted view. In some examples, the data in the formatted view is arranged. For example, the content can be organized in the formatted view based on specifications and guidelines included in the selected transformer plugin.

At block 210, the formatted view and the data is sent to the client platform for presentation. In some examples, the processor can receive the formatted view from the selected transformer plugin and forward the formatted view to the appropriate corresponding platform that sent the request.

It is to be understood that the process diagram of FIG. 2 is not intended to indicate that all of the elements of the method 200 are to be included in every case. Further, any number of additional elements not shown in FIG. 2 can be included in the method 200, depending on the details of the specific implementation. For example, the method can include displaying the formatted view within the client platform. The method 200 can also include receiving a second request for a service endpoint from a second client platform. The method 200 can include extracting a second platform identifier from the second request and selecting a second transformer plugin based on the second platform identifier. The method 200 can also further include formatting, via the second transformer plugin, a second view of data from the service endpoint to visually fit the second client platform and sending the second formatted view of data and the data to the second client platform for presentation. In some examples, the method 200 can also include caching the formatted view of data for a predefined and configurable amount of time. For example, the formatted view of data is cached by the associated transformer plugins for each of the platforms 102. The cached formatted view of data can be sent in response to additional requests received within the predefined or configured amount of time from the same client platform that are detected as being identical to the request. In some examples, the predefined amount of time is provided by the client platform. Whether to cache a formatted view of data and the amount of time to cache a formatted view of data can be determined by the transformer plugin generating the formatted view.

As one example, if a request from a first platform for a list of devices with batteries about to fail this week is received, the corresponding information from the service will be formatted and cached. Then, if a second request from the first platform binds to the same report and dates and is thus detected as identical, the cached formatted view and content may be returned instead of forwarding the request to the service. However, if a new request asks for devices with batteries about to fail from a different range of dates, then the request is treated as a completely different report and the cached formatted view is not used. This second request from the first platform is forwarded and the content formatted and the formatted view cached. The first platform may now have two associated cached formatted views.

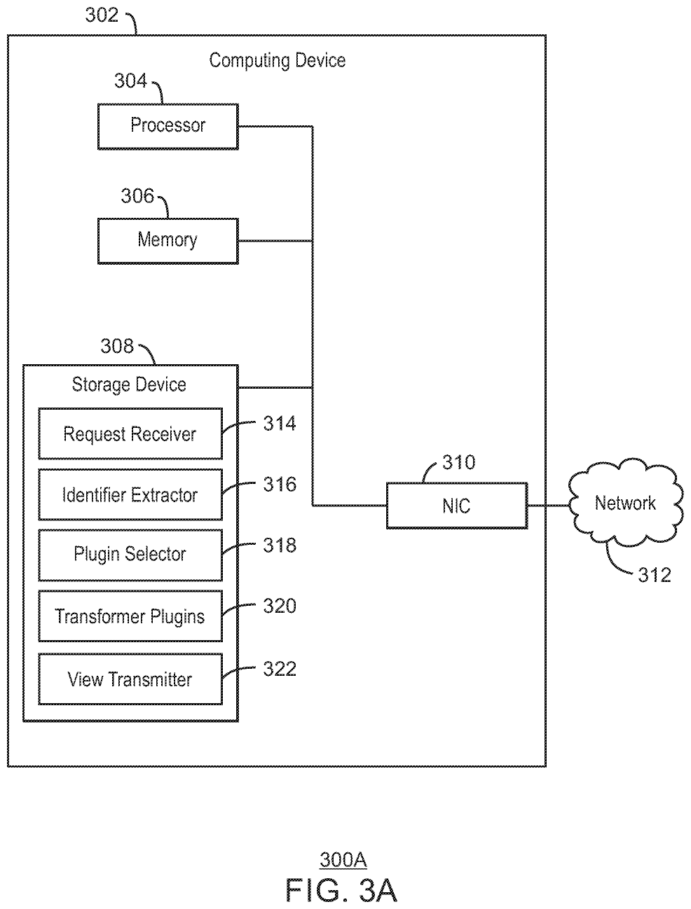

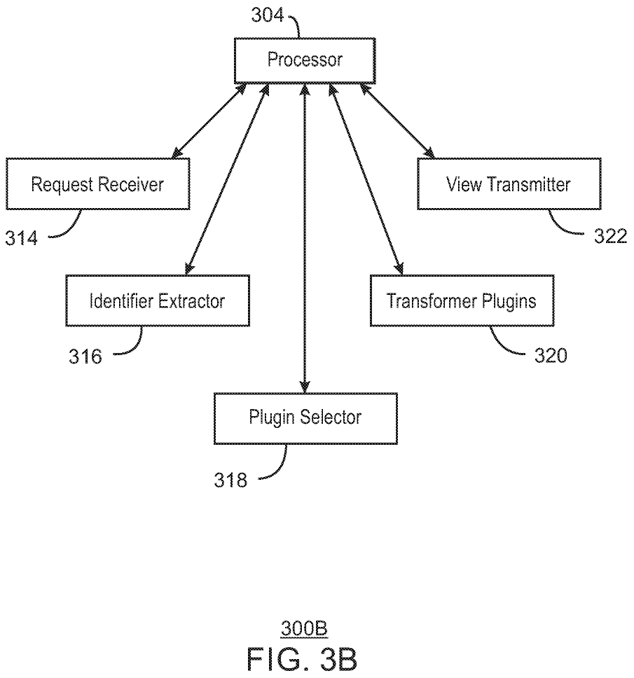

FIG. 3A is a block diagram of an example apparatus 300A including a computing device 302 to format views using transformer plugins. In some examples, the computing device 302 can be a modified backend server. For example, the computing device 302 can be a data-as-a-service (DaaS) backend server. The computing device 302 can include a processor 304, memory 306, a machine-readable storage device 308, and a network interface 310 to connect computing device 302 to network 312. For example, the network interface 310 can be a network interface card (NIC).

In some examples, the processor 304 can be a main processor that is adapted to execute the stored instructions. Moreover, more than one processor 304 can be employed. Further, the processor 304 can be a single core processor, a multi-core processor, a computing cluster, or any number of other configurations. The processor 304 can be implemented as Complex Instruction Set Computer (CISC) or Reduced Instruction Set Computer (RISC) processors, x86 Instruction set compatible processors, ARMv7 Instruction set compatible processors, multi-core, or any other microprocessor or central processing unit (CPU).

The memory 306 can be a memory device. The memory 306 can be volatile memory or nonvolatile memory. In some examples, the memory 306 can include random access memory (RAM), cache, read only memory (ROM), flash memory, and other memory systems.

The storage device 308 is machine-readable storage medium and can include volatile and nonvolatile memory. In some examples, the machine-readable storage medium can be electronic, magnetic, optical, or other physical storage device that stores executable instructions (e.g., code, logic). Thus, the machine-readable storage medium can be, for example, RAM, an Electrically-Erasable Programmable Read-Only Memory (EEPROM), a storage drive such as a hard drive or solid state drive (SSD), an optical disc, and the like. The storage device 308 can also include storage or memory external to the computing device 302. Moreover, as described below, the machine-readable storage medium 308 can be encoded with executable instructions (e.g., executed by the processor 304) for generating formatted views. For example, the machine-readable storage medium can be encoded with executable instructions for selecting transformer plugins based on platform identifiers.

In some examples, a network interface 310 (e.g., a network interface card or NIC) can couple the computing device 302 to a network 312. For example, the network interface 310 can connect computing device 302 to a local network 312, a virtual private network (VPN), or the Internet. In some examples, the network interface 310 can include an Ethernet controller.

The storage device 308 can also include a request receiver 314, an identifier extractor 316, a plugin selector 318, transformer plugins 320, and a view transmitter 322. The request receiver 314 can receive a request for a service endpoint from a client platform. The identifier extractor 316 can extract a platform identifier from the request. For example, the identifier extractor 316 can extract the platform identifier from an extended request header information in the request. In some examples, the identifier extractor 316 can generate the platform identifier based on content in the request. The plugin selector 318 can select a transformer plugin based on the platform identifier. The transformer plugins 320 can format a view of data from the service endpoint to visually fit the client platform. For example, a transformer plugin 320 can exclude a subset of the data from the formatted view for a particular associated client platform. In some examples, a transformer plugin 320 can arrange the data in the formatted view. For example, arranging the data in the formatted view can include formatting text or layout of the text or other content. In some examples, the transformer plugin 320 can also specify that a formatted view is to be cached and configure an amount of time that the formatted view is to be cached. The view transmitter 322 can send the formatted view of data and the data to the client platform for presentation. In some examples, the view transmitter 322 can send the cached formatted view to the client platform for presentation in response to the identifier extractor 316 detecting that a second request from the client platform is identical to the request corresponding to the cached formatted view.

The request receiver 314, identifier extractor 316, plugin selector 318, transformer plugins 320, and view transmitter 322 can be instructions (e.g., code, logic, etc.) stored in the machine-readable storage device 308 and executed by the processor 304 or other processor to direct the computing device 300 for example, to implement method 200 described with respect to FIG. 2. An application-specific integrated circuit (ASIC) can also be employed. In other words, an ASIC can be customized to implement the method 200 via the request receiver 314, identifier extractor 316, plugin selector 318, transformer plugins 320, and view transmitter 322.

The block diagram of FIG. 3A is not intended to indicate that the computing device 302 is to include all of the components shown in FIG. 3A. For example, the request receiver 314 can be a request interceptor to intercept requests from the client platform and intercepting views of data from the service endpoint. Further, the computing device 302 can include any number of additional components not shown in FIG. 3A, depending on the details of the specific implementation. For example, the computing device 302 can include a frontend displayer to display the formatted view on a display. In some examples, the frontend displayer can be part of an application included in the storage device 308.

FIG. 3B is a block diagram of an example apparatus 300A including a computing device 302 to format views using transformer plugins. The example apparatus 300A includes the processor 304, the request receiver 314, the identifier extractor 316, the plugin selector 318, the transformer plugins 320, and the view transmitter 322 as described in FIG. 3A.

The block diagram of FIG. 3B is not intended to indicate that the computing device 302 is to include all of the components shown in FIG. 3B. Again, the request receiver 314 can be a request interceptor to intercept requests from the client platform and intercepting views of data from the service endpoint. Further, the apparatus 300B can include any number of additional components not shown in FIG. 3B, depending on the details of the specific implementation. For example, the apparatus 300B can include a frontend displayer to display the formatted view on a display. In some examples, the frontend displayer can be part of an application included in the storage device 308.

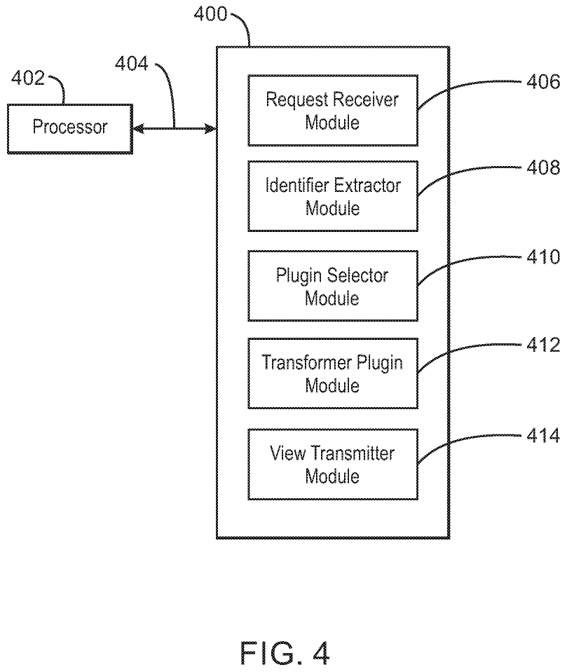

FIG. 4 is a block diagram showing a tangible, non-transitory, machine-readable storage medium that stores code to direct a processor to format views using transformer plugins. The machine-readable medium 400 can include RAM, a hard disk drive, an array of hard disk drives, an optical drive, an array of optical drives, a non-volatile memory, a flash drive, a digital versatile disk (DVD), or a compact disk (CD), among others. The machine-readable storage medium 400 can be accessed by a processor 402 over a bus 404. The processor 402 can be a processor of a computing device, such as the processor 304 of FIG. 3. In some examples, the processor 402 can be a field-programmable gate array (FPGA) processor and/or an ASIC processor. Furthermore, as indicated, the machine-readable medium 400 can include code configured to perform the methods and techniques described herein. Indeed, the various logic components discussed herein can be stored on the machine-readable medium 400. Portions 406, 408, 410, and 412 of the machine-readable storage medium 400 can include request receiver code, application detector code, plugin selector code, and response generator code, respectively, which can be executable code (machine readable instructions) that direct a processor or controller in performing the techniques discussed with respect to the preceding figures.

Indeed, the various logic (e.g., instructions, code) components discussed herein can be stored on the tangible, non-transitory machine-readable medium 400 as indicated in FIG. 4. For example, the machine-readable medium 400 can include the request receiver code 406 that, when executed by a processor, direct the processor or a computing device to intercept a request for a service endpoint from a client platform. For example, the processor can intercept a request from the client platform for content from the service endpoint. The machine-readable medium 400 can also include identifier extractor code 408 that when executed by a processor to direct the processor or a computing device to extract a platform identifier from the request. The processor can extract the platform identifier from extended header information in the request. For example, the plugin selector code 410 can cause the processor to detect an extended request header information in the intercepted request and extract the platform identifier from the extended request header information. In some examples, the plugin selector code 410 can cause the processor to generate the platform identifier based on content in the request. The machine-readable medium 400 can further include plugin selector code 410 that, when executed by a processor, direct the processor or a computing device to select a transformer plugin based on the platform identifier. In some examples, the plugin selector code 410 can cause the processor or a computing device to select a default transformer plugin in response to not detecting any platform identifier or in response to not detecting any transformer plugin associated with an extracted platform identifier. The machine-readable medium 400 can further include transformer plugin code 412 that, when executed by a processor, direct the processor or a computing device to intercept data from the service endpoint corresponding to the request and format a view of data from the service endpoint to visually fit the client platform. For example, the data from the service endpoint can be JSON content. The transformer plugin code 412 can direct the processor to exclude a subset of the intercepted data from the formatted view. In some examples, the transformer plugin code 412 directs the processor to arrange the intercepted data in the formatted view. In some examples, the transformer plugin code 412 can direct the processor to specify that a formatted view is to be cached and configure an amount of time that the formatted view is to be cached. The machine-readable medium 400 can further include view transmitter code 414 that, when executed by a processor, direct the processor or a computing device to send the formatted view and the intercepted data to the client platform for presentation. For example, the formatted view can then be displayed on a device used to implement the client platform. In some examples, the view transmitter code 414 can cause the processor or computing device to send a cached formatted view to a client platform for presentation in response to the identifier extractor 316 detecting that a second request from the client platform is identical to the request corresponding to the cached formatted view.

Although shown as contiguous blocks, the logic components can be stored in any order or configuration. For example, if the machine-readable medium 400 is a hard drive, the logic components can be stored in non-contiguous, or even overlapping, sectors.

While the present techniques may be susceptible to various modifications and alternative forms, the examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A computer-implemented method for dynamically formatting data, comprising:
receiving a request for a service endpoint from a client platform;
extracting a platform identifier from the request;
selecting a transformer plugin based on the platform identifier;
formatting, via the selected transformer plugin, a view of data from the service endpoint to visually fit the client platform; and
sending the formatted view and the data to the client platform for presentation.

2. The method of claim 1, comprising intercepting the request from the client platform and intercepting the view of data from the service endpoint.

3. The method of claim 1, comprising caching the formatted view of data for a predefined or configurable amount of time and providing the formatted view of data to the client platform in response to detecting that a second request from the client platform received within the predefined or configurable amount of time is identical to the request.

4. The method of claim 1, wherein formatting the view of data comprises excluding data from the formatted view.

5. The method of claim 1, wherein formatting the view of data comprises arranging the data in the formatted view.

6. The method of claim 1, wherein extracting the platform identifier comprises detecting extended request header information in the request and extracting the platform identifier from the extended request header information.

7. An apparatus, comprising a processor to:
receive a request for a service endpoint from a client platform;
extract a platform identifier from the request;
select a transformer plugin based on the platform identifier;
format, via the selected transformer plugin, a view of data from the service endpoint to visually fit the client platform; and
send the formatted view of data and the data to the client platform for presentation.

8. The apparatus of claim 7, wherein the platform identifier is to be extracted from an extended request header information in the request.

9. The apparatus of claim 7, wherein platform identifier is to be generated based on the request via a trained classifier.

10. The apparatus of claim 7, wherein client platform comprises an application of a mobile device or a wearable device.

11. The apparatus of claim 7, wherein the client platform comprises a virtual assistant application or a desktop application.

12. A machine-readable storage medium encoded with instructions executable by a processor, the machine-readable storage medium comprising instructions to:
intercept a request for a service endpoint from a client platform;
extract a platform identifier from the request;
select a transformer plugin based on the platform identifier;
intercept data from the service endpoint corresponding to the request;
format a view of the intercepted data from the service endpoint to visually fit the client platform; and
send the formatted view and the intercepted data to the client platform for presentation.

13. The machine-readable storage medium of claim 12, comprising instructions to exclude a subset of the intercepted data from the formatted view or arrange the intercepted data in the formatted view.

14. The machine-readable storage medium of claim 12, comprising instructions to cache the formatted view for a predefined or configurable amount of time and send the cached formatted view to the client platform for presentation in response to detecting that a second request from the client platform received within the predefined or configurable amount of time is identical to the request corresponding to the cached formatted view.

15. The machine-readable storage medium of claim 12, comprising instructions to detect an extended request header information in the intercepted request and extract the platform identifier from the extended request header information.
